(19) United States
(12) Patent Application Publication
(10) Pub. No.: US 2018/0189509 A1
(43) Pub. Date: Jul. 5, 2018

(54) Purpose-Based Control of Data Used by Computer Software Applications

(71) Applicant: International Business Machines Corporation, Armonk, NY (US)

(72) Inventors: Abigail Goldsteen, Haifa (IL); Sima Nadler, Kochav Yair (IL)

(21) Appl. No.: 15/397,753

(22) Filed: Jan. 4, 2017

(51) Int. Cl. G06F 21/62; G06F 21/60

(52) U.S. Cl. CPC G06F 21/6218; G06F 21/604

(57) ABSTRACT

Controlling computer-based access to data by receiving from a computer software application a request specifying a computer user, a type of data associated with an entity, and an intended purpose for the type of data associated with the entity, accessing, responsive to receiving the request, a consent record indicating an association between the specified entity, the specified type of data associated with the entity, and the computer software application, and granting the request if the consent record includes an indication of consent in association with a specified purpose for the type of data associated with the entity, and if the specified purpose matches the intended purpose.

### BACKGROUND

Often when installing a computer software application on a computing device, such as on a so-called “smartphone” or other portable computing device, the user of the device is asked to indicate their consent to permit the computer software application being installed to access their personal information, such as their contact data or their location data, via such devices. However, many privacy directives and laws dictate that data relating to a person, such as personally identifiable information (PII), may be used only for approved purposes, and may only be stored and used for as long as is necessary with respect to the purpose to which the person consented.

### SUMMARY

In one aspect of the invention a method is provided for controlling computer-based access to data, the method including receiving from a computer software application a request specifying a computer user, a type of data associated with an entity, and an intended purpose for the type of data associated with the entity, accessing, responsive to receiving the request, a consent record indicating an association between the specified entity, the specified type of data associated with the entity, and the computer software application, and granting the request if the consent record includes an indication of consent in association with a specified purpose for the type of data associated with the entity, and if the specified purpose matches the intended purpose.

In other aspects of the invention systems and computer program products embodying the invention are provided.

### BRIEF DESCRIPTION OF THE DRAWINGS

Aspects of the invention will be understood and appreciated more fully from the following detailed description taken in conjunction with the appended drawings in which:

FIG. 1 is a simplified conceptual illustration of a system for purpose-based control of data, constructed and operative in accordance with an embodiment of the invention;

FIG. 2 is a simplified flowchart illustration of an exemplary method of operation of the system of FIG. 1, operative in accordance with various embodiments of the invention;

FIG. 3 is a simplified conceptual illustration of a system for purpose-based control of data, constructed and operative in accordance with an additional embodiment of the invention;

FIG. 4 is a simplified flowchart illustration of an exemplary method of operation of the system of FIG. 1, operative in accordance with various embodiments of the invention;

and

FIG. 5 is a simplified block diagram illustration of an exemplary hardware implementation of a computing system, constructed and operative in accordance with an embodiment of the invention.

### DETAILED DESCRIPTION

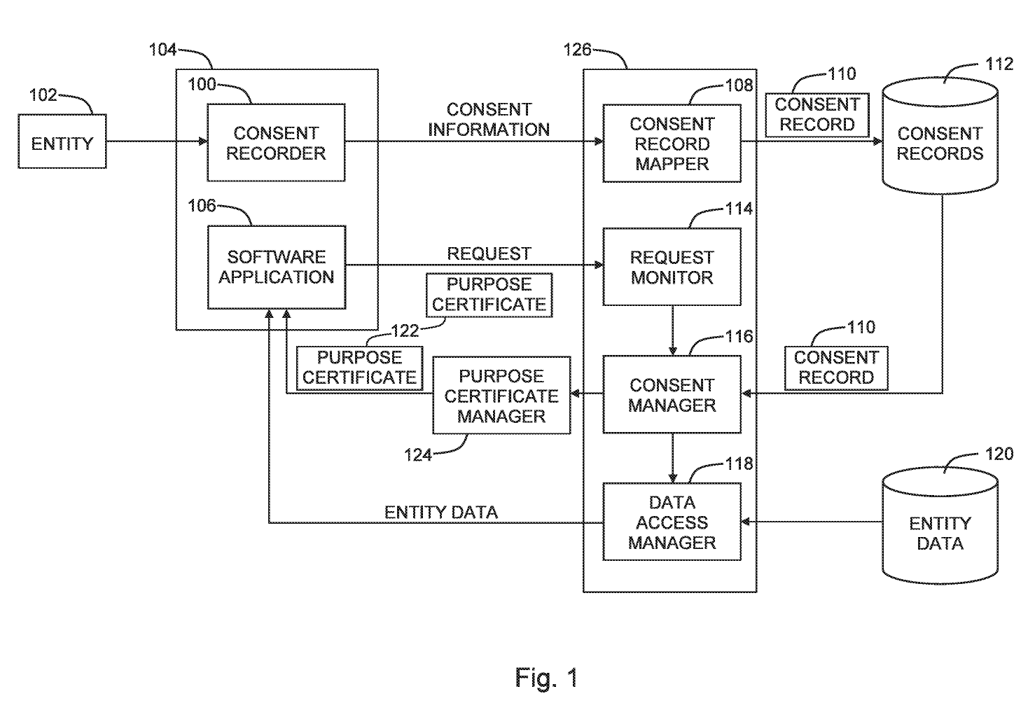

Reference is now made to FIG. 1, which is a simplified conceptual illustration of a system for purpose-based control of data, constructed and operative in accordance with an embodiment of the invention. In the system of FIG. 1, a consent recorder 100 is configured to receive, from an entity 102, an indication of consent by entity 102 for a specified computer software application to act upon one or more specified types of data associated with the entity for one or more specified purposes. In various embodiments entity 102 is an individual or a computer software application. In various embodiments, data that are described herein as being associated with an entity include any of data that are provided by, for, or concerning the entity, and data that are owned by or otherwise belong to the entity. In one embodiment, entity 102 is a user of a computing device 104, such as a smartphone or other portable computing device. In one embodiment, consent recorder 100 receives the above information from entity 102 during the installation of a computer software application 106 onto computing device 104, where consent recorder 100 displays a prompt for the above information on a display of computing device 104, the displayed prompt identifying computer software application 106, specifying the type(s) of data associated with entity 102 that computer software application 106 wishes to act upon, such as to gather, store, and/or otherwise access and use the data, and specifying the purpose(s) for which computer software application 106 wishes to act upon the specified type(s) of data. For example, computer software application 106 may be a reminder application that uses calendar event information and contact information belonging to a user of computing device 104 for the purpose of sending periodic reminders to the user's contacts that are associated with the user's calendar events. In this example, during the installation of the reminder application onto computing device 104, consent recorder 100 displays a prompt on the display of computing device 104 identifying the reminder application and asking the user of computing device 104 to indicate their consent to allow the reminder application to use calendar event information and contact information belonging to the user for the purpose of sending periodic reminders to the user's contacts that are associated with the user's calendar events.

A consent record manager 108 is configured to maintain the above information received from entity 102 in a consent record 110 associating entity 102 with the specified type(s) of data associated with entity 102, computer software application 106, the specified purpose(s) for which computer software application 106 wishes to act upon the specified type(s) of data, and the indication of consent by entity 102 for computer software application 106 to act upon the specified type(s) of data for the specified purpose(s). Consent record manager 108 is configured to maintain consent record 110 in a data store of such consent records 112.

A request monitor 114 is configured to receive from computer software application 106 a request specifying entity 102, one or more types of data associated with entity 102, and one or more intended purposes for acting upon the specified type(s) of data associated with entity 102. Continuing with the previous example, request monitor 114 receives a request from computer software application 106 on computing device 104, the request specifying the user of computing device 104, requesting access to the calendar event information and contact information of the user, and indicating an intended purpose of sending a reminder to the user's contacts that are associated with the user's calendar events.

A consent manager 116 is configured to react to receipt of the above request by request monitor 114 by searching consent records 112 for a consent record indicating an association between entity 102, the type(s) of data associated with entity 102, and computer software application 106, all as specified in the request from computer software application 106. If such a consent record is found, such as consent record 110, consent manager 116 accesses consent record 110 and grants the request if consent record 110 includes an indication of consent in association with one or more specified purpose(s) for the type(s) of data associated with entity 102, and if the specified purpose(s) matches the intended purpose(s) as specified in the request received from computer software application 106.

In one embodiment where the request is a request to store data that have been gathered by computer software application 106, consent manager 116 grants the request by instructing a data manager 118 to store the gathered data in a data store 120, preferably together with the identities of entity 102 and computer software application 106, the purpose(s) specified by computer software application 106 regarding the data, and the indication of consent by entity 102 for computer software application 106 to act upon the data for the specified purpose(s). Before allowing the data to be stored for this request, as well as for such requests to store data that are received on an ongoing basis, consent manager 116 checks for an applicable consent record 110 with a corresponding indication of consent as described above, and/or checks the request itself for the corresponding indication of consent. Where the indication of consent by entity 102 or the purpose(s) specified by computer software application 106 regarding the data being gathered indicates the duration for which the data is to be stored and available for the specified purpose(s), data manager 118 preferably deletes the data from data store 120 at the end of the specified period.

In one embodiment where the request is a request to receive data, consent manager 116 grants the request by instructing a data manager 118 to provide the requested data to computer software application 106, such as from a data store 120 where data associated with entity 102 are stored after having been gathered in accordance with conventional techniques.

In one embodiment, computer software application 106 possesses one or more purpose certificates 122 corresponding to one or more predefined purposes for which computer software application 106 is certified in accordance with conventional techniques, such as where computer software application 106 receives purpose certificates 122 from a purpose certificate manager 124. In this embodiment, when computer software application 106 issues a request as described above to act upon one or more type(s) of data associated with entity 102 for one or more intended purposes, computer software application 106 provides, as part of the request, the purpose certificate 122 that corresponds to the intended purpose(s). Consent manager 116, in addition to processing the request as described above, is configured to validate purpose certificate 122 in accordance with conventional techniques, such as by sending purpose certificate 122 to purpose certificate manager 124 for validation thereat, or by requesting a copy of the valid purpose certificates of computer software application 106 from purpose certificate manager 124 for comparison with purpose certificate 122. In this embodiment, consent manager 116 grants the request based on consent record 110 as described above, provided that purpose certificate 122 is valid for the intended purpose(s).

In one embodiment, consent record 110 includes one or more consent directives stipulated by entity 102, where consent manager 116 grants the request based on consent record 110 as described above, but does so in accordance with the consent directive(s) included in consent record 110. In one example of this, a consent directive indicates that some or all of the requested data be obfuscated in a particular manner before being provided to computer software application 106.

In one embodiment, consent record 110 includes one or more consent conditions stipulated by entity 102, where consent manager 116 grants the request based on consent record 110 as described above, but does so provided that the request meets the consent condition(s), where consent manager 116 is configured to determine whether the request meets the consent condition(s). Some examples of such consent conditions include: that the request be granted only at certain times of the day; that the request be granted only when the computing device that hosts computer software application 106 is located at a predefined location; and that the request be granted only if entity 102 is a member of a particular organization or group or has a predefined role.

Any of the elements shown in FIG. 1 are preferably implemented by one or more computers in computer hardware and/or in computer software embodied in a non-transitory, computer-readable medium in accordance with conventional techniques. In one embodiment, computer software application 106 and consent recorder 100 are hosted by computing device 104, while consent record manager 108, request monitor 114, consent manager 116, data manager 118, and purpose certificate manager 124 are hosted by one or more other computers, such as by a computer 126, which may be an enterprise server, where the elements shown in FIG. 1 communicate via a computer network, such as the Internet.

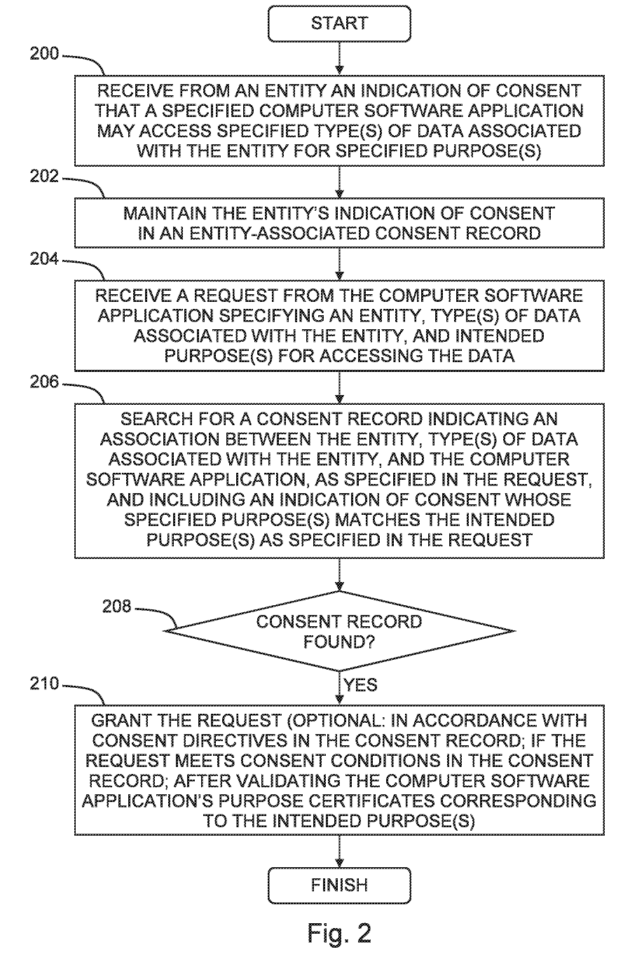

Reference is now made to FIG. 2, which is a simplified flowchart illustration of an exemplary method of operation of the system of FIG. 1, operative in accordance with an embodiment of the invention. In the method of FIG. 2, an indication of consent is received from an entity, where the indication of consent indicates that a specified computer software application may act upon one or more specified types of data associated with the entity for one or more specified purposes (step 200). A consent record is maintained associating the entity with the specified type(s) of data associated with the entity, the computer software application, the specified purpose(s) for which the computer software application may act upon the specified type(s) of data, and the indication of consent by the entity (step 202). A request is received from the computer software application specifying an entity, one or more types of data associated with the entity, and one or more intended purposes for acting upon the specified type(s) of data associated with the entity (step 204). A search is conducted for a consent record indicating an association between the entity, the type(s) of data associated with the entity, and the computer software application, all as specified in the request, and including an indication of consent in association with one or more specified purpose(s) for the type(s) of data associated with the entity, where the specified purpose(s) matches the intended purpose(s) as specified in the request received from the computer software application (step 206). If such a consent record is found (step 208), the request is granted (step 210), such as by providing the requested data to the computer software application. Optionally, the request is granted in accordance with consent directives that are included in the consent record and/or provided that the request meets consent conditions that are included in the consent record. Optionally, the request is granted after determining that the computer software application possesses valid purpose certificates corresponding to the intended purpose(s).

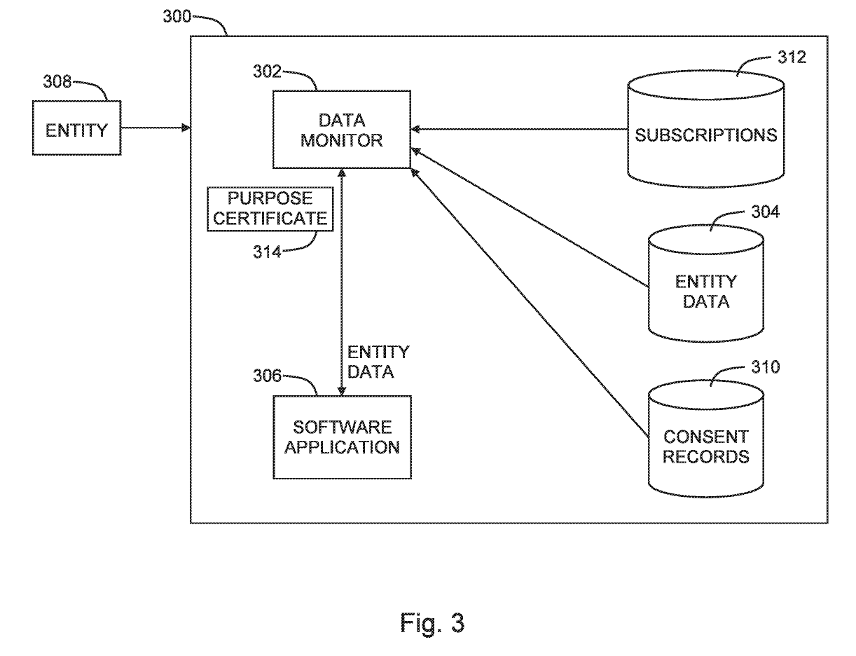

Reference is now made to FIG. 3, which is a simplified conceptual illustration of a system for purpose-based control of data, constructed and operative in accordance with an additional embodiment of the invention. In the system of FIG. 3, a computing device 300, which may otherwise be configured as described hereinabove with reference to computing device 104 of FIG. 1, includes a data monitor 302 which is configured to monitor data 304 as they are gathered by computing device 300 in accordance with conventional techniques, such as where data 304 are gathered by the operating system of computing device 300 or by one or more computer software applications 306 that are hosted by computing device 300. Data 304 includes, for example, the location of computing device 300 at various times, calendar events, message received from remote systems (e.g., push notifications), and readings device sensors (e.g., gyroscope). Each item of data 304 is preferably associated with an entity 308, such as is described hereinabove with reference to entity 102 of FIG. 1, where each item of data 304 is preferably stored together with the identity of its associated entity 308. Indications of consent by entity 308 for a specified computer software application 306 to act upon one or more specified types of data 304 associated with entity 308 for one or more specified purposes are preferably recorded and stored as consent records 310 and/or together with data 304, such as is described hereinabove with reference to the consent records and entity-associated data of FIGS. 1 and 2.

When a new item of data 304 is identified by data monitor 302, data monitor 302 identifies any computer software applications 306 that previously subscribed to receive the item of data 304 for one or more specified purposes, where such subscription and purpose information and the identity of the subscribers are preferably maintained in a subscription data store 312. Data monitor 302 checks for a corresponding indication of consent by entity 308 for the specified purpose in consent records 310 or in the item of data 304. For each subscribing computer software application 306, if such an indication of consent is found, and optionally if the subscribing computer software application 306 possesses a valid purpose certificate 314 corresponding to the specified purpose as described hereinabove with reference to FIGS. 1 and 2, data monitor 302 provides the item of data 304 to the subscriber.

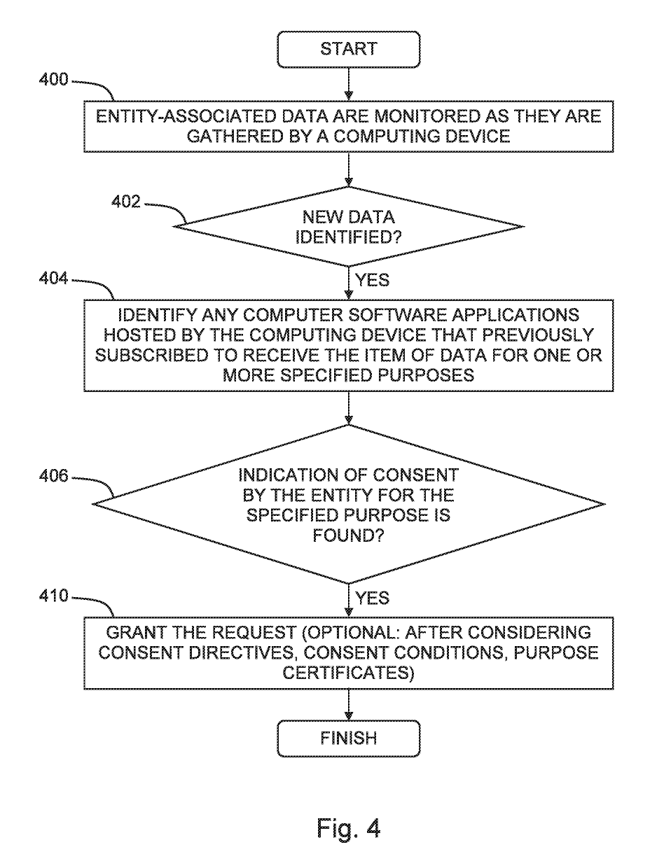

Reference is now made to FIG. 4, which is a simplified flowchart illustration of an exemplary method of operation of the system of FIG. 1, operative in accordance with an embodiment of the invention. In the method of FIG. 4, entity-associated data are monitored as they are gathered by a computing device (step 400). When a new item of data is identified (step 402), identification is made of any computer software applications hosted by the computing device that previously subscribed to receive the item of data for one or more specified purposes (step 404). If a corresponding indication of consent by the entity for the specified purpose is found (step 406), the item of data is provided to the subscriber (step 408), optionally after considering consent directives, consent conditions, and purpose certificates as described hereinabove with reference to FIGS. 1 and 2.

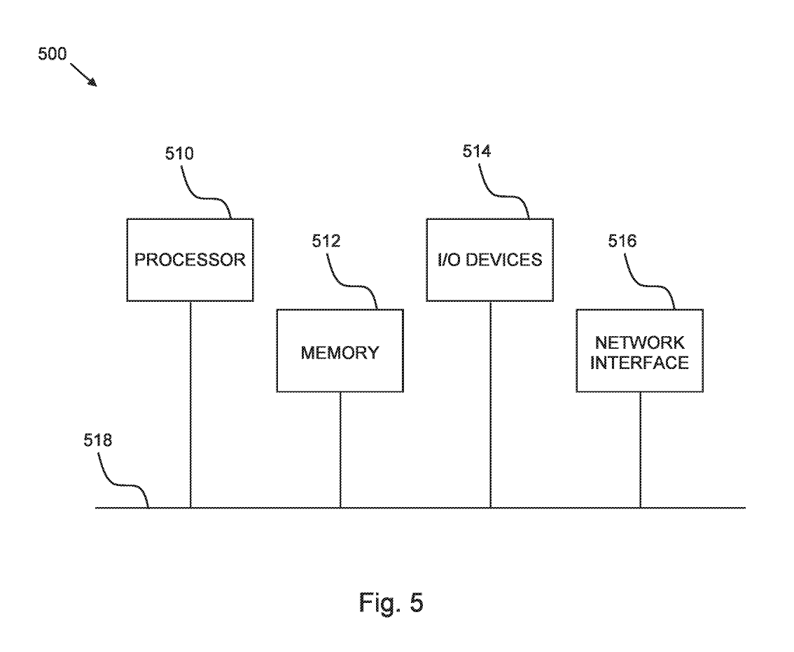

Referring now to FIG. 5, block diagram 500 illustrates an exemplary hardware implementation of a computing system in accordance with which one or more components/methodologies of the invention (e.g., components/methodologies described in the context of FIGS. 1-4) may be implemented, according to an embodiment of the invention. As shown, the invention may be implemented in accordance with a processor 510, a memory 512, I/O devices 514, and a network interface 516, coupled via a computer bus 518 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for controlling computer-based access to data, the method comprising:
receiving from a computer software application a request specifying a computer user, a type of data associated with an entity, and an intended purpose for the type of data associated with the entity;
accessing, responsive to receiving the request, a consent record indicating an association between the specified entity, the specified type of data associated with the entity, and the computer software application; and
granting the request if the consent record includes an indication of consent in association with a specified purpose for the type of data associated with the entity, and if the specified purpose matches the intended purpose.

2. The method according to claim 1 and further comprising:
receiving from the entity the indication of consent for the computer software application to act upon the specified type of data associated with the entity for the specified purpose; and
maintaining the consent record associating the entity, the specified type of data associated with the entity, the computer software application, the indication of consent, and the specified purpose for the type of data associated with the entity.

3. The method according to claim 2 wherein the receiving from the entity and the maintaining are performed prior to receiving the request from the computer software application.

4. The method according to claim 2 wherein the receiving from the entity comprises receiving wherein the entity is an individual.

5. The method according to claim 1 wherein the receiving comprises receiving wherein the request is a request by the computer software application to perform any of gathering, storing, or accessing the type of data associated with the entity.

6. The method according to claim 1 wherein
the accessing comprises accessing wherein the consent record includes a consent directive, and
the granting comprises granting the request only in accordance with the consent directive.

7. The method according to claim 1 wherein
the accessing comprises accessing wherein the consent record includes a consent condition, and
the granting comprises granting the request only if the request meets the consent condition.

8. The method according to claim 1 wherein the receiving, accessing, and granting are implemented in any of
a) computer hardware, and
b) computer software embodied in a non-transitory, computer-readable medium.

9. A system for controlling data associated with an entity, the system comprising:
a request monitor configured to receive from a computer software application a request specifying an entity, a type of data associated with the entity, and an intended purpose for the type of data associated with the entity; and
a consent manager configured to
access a consent record indicating an association between the specified entity, the specified type of data associated with the entity, and the computer software application, and
grant the request if the consent record includes an indication of consent in association with a specified purpose for the type of data associated with the entity, and if the specified purpose matches the intended purpose.

10. The system according to claim 9 and further comprising:
a consent recorder configured to receive from the entity the indication of consent for the computer software application to act upon the specified type of data associated with the entity for the specified purpose; and
a consent record manager configured to maintain the consent record associating the entity, the specified type of data associated with the entity, the computer software application, the indication of consent, and the specified purpose for the type of data associated with the entity.

11. The system according to claim 9 wherein the entity is an individual.

12. The system according to claim 9 wherein the request is a request by the computer software application to perform any of gathering, storing, or accessing the type of data associated with the entity.

13. The system according to claim 9 wherein
the consent record includes a consent directive, and
the consent manager is configured to grant the request only in accordance with the consent directive.

14. The system according to claim 13 wherein
the consent directive includes a consent condition, and
the consent manager is configured to determine whether the request meets the consent condition and grant the request only if the request meets the consent condition.

15. The system according to claim 9 wherein the request monitor and the consent manager are implemented in any of
a) computer hardware, and
b) computer software embodied in a non-transitory, computer-readable medium.

16. A computer program product for controlling data associated with an entity, the computer program product comprising:
a non-transitory, computer-readable storage medium; and
computer-readable program code embodied in the storage medium, wherein the computer-readable program code is configured to
receive from a computer software application a request specifying an entity, a type of data associated with the entity, and an intended purpose for the type of data associated with the entity, and
access a consent record indicating an association between the specified entity, the specified type of data associated with the entity, and the computer software application, and
grant the request if the consent record includes an indication of consent in association with a specified purpose for the type of data associated with the entity, and if the specified purpose matches the intended purpose.

17. The computer program product according to claim 16 wherein the computer-readable program code is configured to
receive from the entity the indication of consent for the computer software application to act upon the specified type of data associated with the entity for the specified purpose, and
maintain the consent record associating the entity, the specified type of data associated with the entity, the computer software application, the indication of consent, and the specified purpose for the type of data associated with the entity.

18. The computer program product according to claim 16 wherein the request is a request by the computer software application to perform any of gathering, storing, or accessing the type of data associated with the entity.

19. The computer program product according to claim 16 wherein
the consent record includes a consent directive, and
the computer-readable program code is configured to grant the request only in accordance with the consent directive.

20. The computer program product according to claim 16 wherein
the consent directive includes a consent condition, and
the computer-readable program code is configured to determine whether the request meets the consent condition and grant the request only if the request meets the consent condition.
